(19) United States
(12) Patent Application Publication
(10) Pub. No.: US 2021/0200055 A1
(43) Pub. Date: Jul. 1, 2021

(54) ADHESION PROMOTION FOR E-PAPER VAPOR BARRIERS

(71) Applicant: HEWLETT-PACKARD DEVELOPMENT COMPANY, L.P., Spring, TX (US)

(72) Inventor: Rajesh KELEKAR, Palo Alto, CA (US)

(73) Assignee: Hewlett-Packard Development Company, L.P., Spring, TX (US)

(21) Appl. No.: 17/047,317

(22) PCT Filed: Aug. 23, 2018
(86) PCT No.: PCT/US2018/047722

§ 371 Date: Oct. 13, 2020

(51) Int. Cl. G02F 1/1679; G02F 1/167; G02F 1/16757; C08F 222/10

(52) U.S. Cl. CPC G02F 1/1679; G02F 1/167; G02F 2202/28; C08F 222/105; G02F 1/16757

(57) ABSTRACT

A passive e-paper assembly includes a charge-transmissible moisture vapor barrier comprising a flexible inorganic material, a charge-responsive, re-writable media layer, and a first adhesion-promoting layer interposed between the moisture vapor barrier and a first side of the charge-responsive media layer.

### BACKGROUND

Electronic paper (“e-paper”) is a display technology designed to recreate the appearance of ink on ordinary paper. Some examples of e-paper reflect light like ordinary paper and may be capable of displaying text and images. Some e-paper may be implemented as a flexible, thin sheet, like paper. One familiar e-paper implementation includes e-readers.

### BRIEF DESCRIPTION OF THE DRAWINGS

FIG. 1 is a side view schematically representing an example passive e-paper assembly including a first adhesion-promoting layer.

FIG. 2 is a block diagram schematically representing example methods and/or materials to form a barrier layer.

FIG. 3 is a block diagram schematically representing example parameters of an example adhesion-promoting layer.

FIG. 4 is a block diagram schematically representing example methods of forming a barrier layer.

FIG. 5 is a side view schematically representing an example passive e-paper assembly like in FIG. 1 and further including an airborne-charge receiving layer and/or a counter electrode layer.

FIG. 6 is a side view schematically representing an example passive e-paper assembly like in FIG. 5 and including an additional adhesion-promoting layer.

FIG. 7 is a block diagram schematically representing example methods of forming a barrier layer.

FIG. 8 is a side view schematically representing an example device and/or example method of manufacturing an e-paper assembly including at least one adhesion-promoting layer.

FIG. 9 is a flow diagram schematically representing an example method.

FIG. 10 is a diagram including a partial sectional view schematically representing an example e-paper assembly and a side plan view schematically representing an example imaging unit.

FIG. 11A is an exploded view schematically representing an example passive e-paper display media.

FIG. 11B is a top plan view schematically representing an assembled passive e-paper display media.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

In some examples, a passive e-paper assembly comprises a charge-transmissible moisture vapor barrier comprising a flexible inorganic material, a charge-responsive, re-writable media layer, and a first adhesion-promoting layer which is interposed between the moisture vapor barrier and a first side of the charge-responsive media layer. In some examples, the first adhesion-promoting layer comprises an electrical resistivity between about 10⁸ and about 10¹³ Ohm-cm. In some examples, when in a liquid state, the first adhesion-promoting layer comprises a wettability contact angle relative to the first side of the media layer of less than about 50 degrees. In some examples, the first adhesion-promoting layer comprises a UV-curable acrylate.

The electrical resistivity facilitates migration of the airborne charges which have been directed to pass through at least the moisture vapor barrier and the first adhesion-promoting layer. The wettability contact angle minimizes “beading” of the first adhesion-promoting layer on the outer surface of the first side of the media layer. In some examples, the electrical resistivity and wetting contact angle may be implemented via a single ingredient of the first adhesion-promoting layer, as further described later.

In some examples, the first adhesion-promoting layer may comprise parameters in addition to (or instead of) the above-described electrical resistivity and/or wetting contact angle. For instance, at least some of the additional parameters may comprise flexibility, elastic modulus (e.g. mechanical stiffness), adhesiveness, residual stress behavior, surface smoothness, and print quality effect.

Via such example arrangements, the first adhesion-promoting layer provides the foundation for a smooth coating and formation of the moisture vapor barrier layer, which in turn yields a robust, effective moisture vapor barrier.

In contrast, inferior primers applied between a moisture barrier and a media layer may cause the moisture vapor barrier to exhibit wrinkling, cracking, etc. which in turn may result in a significantly less effective moisture barrier.

In some examples, by employing the example first adhesion-promoting layer to facilitate a robust, smooth moisture vapor barrier for a passive e-paper assembly, displayed images on the media layer can be retained despite presence of the e-paper assembly in variable humidity conditions, such as very low or very high humidity conditions. For instance, in some examples, the moisture vapor barrier may enable the e-paper assembly to retain a high image quality per a moisture vapor transmission rate (MVTR) of less than about 1 g/m²/week at 38 degrees Celsius and 90% relative humidity. Further details regarding the moisture vapor barrier will be described later.

In some examples, an airborne-charge receiving layer is disposed on the first side of the media layer with the airborne-charge receiving layer being formed or otherwise applied onto the moisture vapor barrier. The airborne-charge receiving layer may serve as a protective layer and is to facilitate migration of charges to the charge-responsive, re-writable media layer. Similarly, the moisture vapor barrier and first adhesion-promoting layer also facilitate migration of charges to the charge-responsive, re-writable media layer.

In some examples, referring to the e-paper assembly as being passive means that the e-paper assembly is electrically passive, i.e. has no active electrode plates, electrode layers, driving electrodes, driving circuits, etc. in order to intentionally cause a change in the image (e.g. information) displayed in the re-writable media layer. Accordingly, in some instances, the passive e-paper assembly may sometimes be referred to as being circuitry-free.

At least in part because the example passive e-paper assembly lacks on on-board power supply and/or internal circuitry, the passive e-paper display media is relatively thin and light, thereby giving the example passive e-paper display a look and feel more like traditional paper.

In some examples, an e-paper assembly may sometimes be referred to as, and/or be incorporated within, an e-paper display media or an e-paper display device.

In some examples, the above-described passive e-paper assembly further comprises a second adhesion-promoting layer interposed between the moisture vapor barrier and the airborne charge receiving layer. In some examples, the second adhesion-promoting layer may comprise at least some of substantially the same features and attributes as the first adhesion-promoting layer while in some examples, the second adhesion-promoting layer may comprise at least some features and attributes differing from the first adhesion-promoting layer.

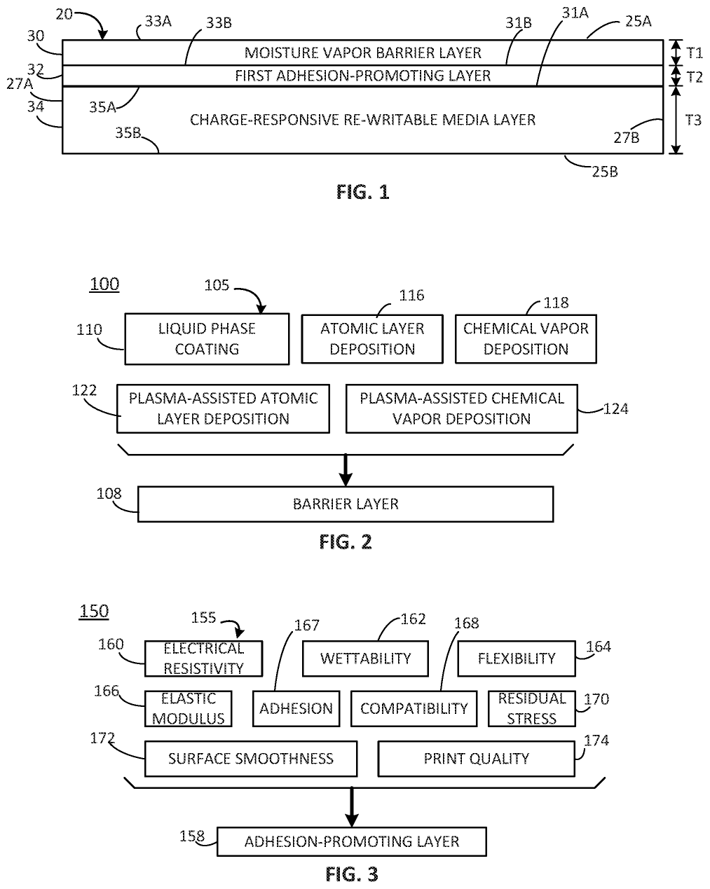

These examples, and additional or other examples, are described below in association with at least FIGS. 1-12B.

FIG. 1 is a side view schematically representing an example passive e-paper assembly 20. In some examples, the e-paper assembly 20 may sometimes be referred to as an e-paper display assembly, e-paper display media, and/or e-paper display device. Moreover, in some examples, e-paper assembly 20 may form part of an example larger e-paper display media or example display device as shown later in association with at least FIGS. 12A-12B.

As shown in FIG. 1, in some examples the passive e-paper assembly 20 comprises a charge-responsive, re-writable media layer 34 including a first side 35A and an opposite second side 35B. A moisture vapor barrier 30 is located on the first side 35A of the charge-responsive media layer 34. The moisture vapor barrier 30 comprises a first side 33A and an opposite second side 33B. The moisture vapor barrier 30 comprises an inorganic material and the moisture vapor barrier 30 is to transmit (e.g. permit migration of) charges to the charge-responsive, re-writable media layer 34 while protecting media layer 34 from moisture vapor.

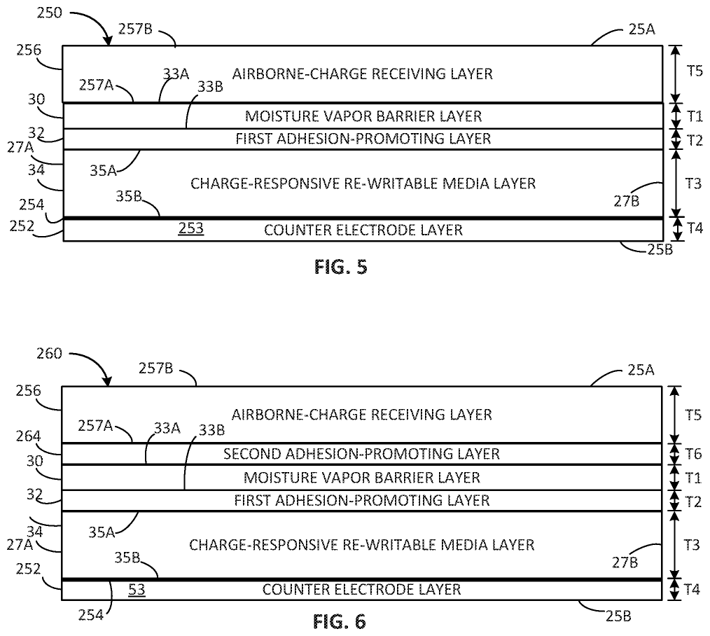

In some examples, the entire passive e-paper assembly 20 is flexible by virtue of each layer 32, 30, 34 being relative thin and highly flexible. In some examples, the flexibility of the entire passive e-paper assembly 20 is maintained even with the addition of other layers, such as the later described airborne-charge receiving layer 256 (FIG. 5), counter electrode 252 (FIG. 5), and/or a second adhesion-promoting layer 264 (FIG. 6).

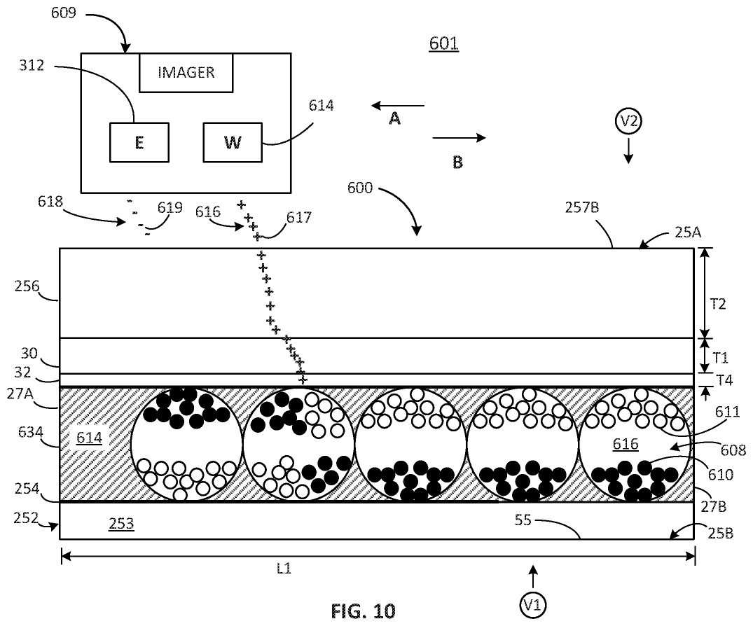

In some examples, referring to the e-paper assembly as being passive means that the e-paper assembly 20 is electrically passive, i.e. has no active electrode plates, electrode layers, drive electrodes, driving circuits etc. to cause a change in the image (e.g. information) displayed in the re-writable media layer 34. Instead, any change in the image displayed is caused by an external imaging unit, such as but not limited to, the imaging unit 609 described later in association with at least FIG. 10. Moreover, as previously noted, the e-paper assembly 20 can be relatively, thin and light because its lacks on-board power supply.

Charge-responsive media layer 34 includes components which switch color (e.g. black, white, etc.) when electrical airborne charges are deposited onto and/or migrate through other layers to the media layer 34. In some examples, the charge-responsive media layer 34 comprises a switchable pigment or die combination. One example of such a charge-responsive media layer 34 (in a passive e-paper assembly) is described later in association with at least FIG. 1, such as media layer 634. In some examples, the charge-responsive, re-writable media layer 34 comprises a thickness (T3) between about 20 microns and about 100 microns. In some examples, the charge-responsive media layer 34 comprises organic material(s).

It is desirable to retain satisfactory image quality in the media layer 34 of the e-paper assembly 20 regardless of where the location and/or type of environment in which the e-paper assembly 20 may be taken. In some instances, a high humidity environment may pose a challenging condition for an e-paper assembly 20 lacking such a moisture vapor barrier 30. However, the inclusion of the moisture vapor barrier 30 in an example passive e-paper assembly 20 may enable high image quality retention even in such high humidity conditions. In some examples, the moisture vapor barrier 30 may enable the e-paper assembly 20 to retain a high image quality per a moisture vapor transmission rate (MVTR) of less than about 0.1 g/m²/day at 38 degrees Celsius and 90% relative humidity. Via such an example moisture vapor barrier, in some examples the e-paper assembly may retain a high quality image via a moisture vapor transmission rate (MVTR) of less than about 1 g/m²/week at 38 degrees Celsius and 90% relative humidity. Further details regarding the moisture vapor barrier 30 are described later in context with the first adhesion-promoting layer 32 and/or other elements of the e-paper assembly 20.

In at least some examples, the example first adhesion-promoting layer 32 may enhance adhesion between the moisture vapor barrier 30 and the charge-responsive media layer 34, as well as enhance a smoothness and effectiveness of the moisture vapor barrier 30.

In some examples, the first adhesion-promoting layer 32 may act like a skin to prevent cracking and/or imperfections in the inorganic moisture vapor barrier 30, such as might otherwise occur in some instances after formation of the inorganic moisture vapor barrier 30 in the absence of the first adhesion-promoting layer 32. Accordingly, the first adhesion-promoting layer 32 may facilitate formation of and retention of a smooth and generally uniform (e.g. generally homogeneous) layer, which provides for a highly durable moisture vapor barrier 30.

With this in mind, in some examples, the first adhesion promoting layer 32 may help homogenize an inhomogeneous surface, which may in turn enhance adhesion relative to the inorganic moisture vapor barrier 30. For instance, in some examples the charge-responsive media layer 34 may comprise an inhomogeneous surface. In some examples, the inhomogeneous surface may comprise capsules in a binder (e.g. FIG. 10), which may exhibit an inhomogeneous surface resulting from its multi-material aggregation.

In some examples, the first adhesion-promoting layer 32 may facilitate adhesion (between the inorganic moisture vapor barrier 30 and an organic layer (e.g. first side 35A of media layer 34) by acting as a bridge for the mismatched chemistries (inorganic vs. organic) of the inorganic moisture vapor barrier 30 relative to the relative to the charge-responsive media layer 34.

As further shown in the diagram 100 of FIG. 2, a barrier layer 108 of e-paper assembly 20 may be formed via one of a plurality 105 of implementations 110, 116, 118, 122, 124, each of which are further described below. In some examples, the barrier layer 108 represented in FIG. 2 may comprise the first adhesion-promoting layer 32 in FIGS. 1, 5-6, 10 while in some examples, the barrier layer 108 in FIG. 2 also may correspond to other barrier layers, such as moisture vapor barrier 30, airborne-charge receiving layer 256, and/or second adhesion-promoting layer 264 as further described later.

In some examples, the first adhesion-promoting layer 32 may comprise an organic polymer material which may be applied as a liquid phase coating, such as represented at 110 in FIG. 2. In some examples, the organic polymer material may be flowable and curable, such as via thermal or ultraviolet (UV) radiation. For instance, the polymer material may comprise a UV curable acrylate, which may comprise some surface functional groups to facilitate adherence to inorganic materials, such as moisture vapor barrier 30. In some examples, when formulated for application as a liquid phase, the first adhesion-promoting layer 32 (as well as the moisture vapor barrier 32, layer 256) may be deposited under atmospheric pressure conditions, which generally correspond to moderate relative humidity conditions.

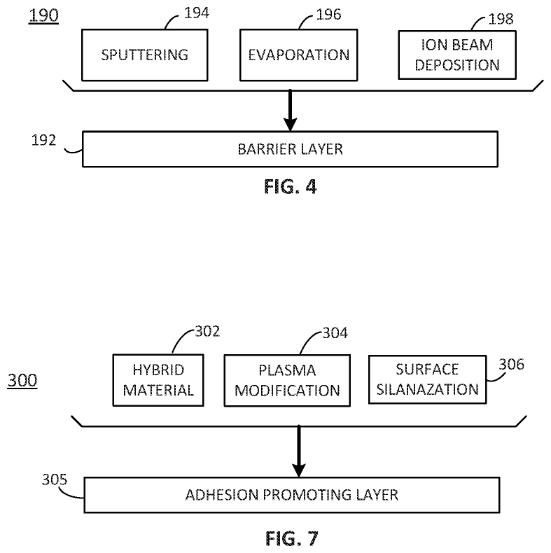

In some examples, the example first adhesion-promoting layer 32 may be formed in a vapor phase in which atoms or molecules condense on a surface to form a thin film. In some examples, such vapor phase deposition may comprise atomic layer deposition 116, chemical vapor deposition 118. In some examples, vapor phase deposition also may comprise plasma-assisted atomic layer deposition 122, and plasma-assisted chemical vapor deposition 124, as shown in the diagram of FIG. 2. As later described in association with FIG. 4, in some examples other forms of vapor deposition may be employed.

In many instances, such vapor deposition is performed under vacuum conditions. However, such vacuum conditions typically exhibit very low relative humidity (e.g. 1%), which in some instances may degrade the passive e-paper (e.g. at least media layer 34) on which layer 32 and barrier 30 are to be formed.

Accordingly, in some examples, application of an organic polymer material into the first adhesion-promoting layer 32 is performed via under atmospheric pressure (i.e. not vacuum conditions) via atmospheric plasma-enhanced chemical vapor deposition (CVD) and/or atmospheric spatial atomic layer deposition (ALD). By doing so, moderate relative humidity conditions (e.g. 30 to 60%) can be maintained, which in turn, avoids potential degradation of the passive e-paper (e.g. at least media layer 34).

However, in some examples, the first adhesion-promoting layer 32 and/or moisture vapor barrier 30 may be formed under vacuum conditions without significant degradation of the deposited layers when the vacuum conditions (and therefore very low humidity such as 0%, 1% relative humidity) are limited to relatively short periods of time (e.g. 10 minutes). In some such examples, the first adhesion-promoting layer 32 and the moisture vapor barrier 30 may be formed under vacuum conditions via plasma-assisted (i.e. plasma-enhanced), chemical vapor deposition 124. In some such examples, the moisture vapor barrier 30 may be formed from a silicon nitride (SiN) material. In some such examples, ceramic materials other than silicon nitride (SiN) may be used to form moisture vapor barrier 30, such as later described below.

In some examples, the first adhesion-promoting layer 32 comprises a thickness (T2) of less than about 250 microns. Accordingly, among other attributes, the relative thinness of the first adhesion-promoting layer 32 (or surface) may help to minimize inhibition of (and/or help facilitate the) migration of charges, such as charges migrating from an airborne-charge receiving layer (e.g. 256 in FIGS. 5-6) to the charge-responsive media layer 34. Accordingly, in some examples the moisture vapor barrier 30 and/or first adhesion-promoting layer 32 may exhibit such anisotropic behavior.

In some examples, the first adhesion-promoting layer 32 may exhibit a resistivity between a lower limit of about 10⁸ Ohm-cm and an upper limit of about 10¹³ Ohm-cm. In some examples, such a range of resistivity is applicable for a thickness (T2) of the first adhesion-promoting layer 32 on the order of microns. In some examples, such a range of resistivity may be applicable for a thickness (T2) on the order of tens of microns. In some such examples, the range of resistivity may comprise about 10⁸ Ohm-cm to about 10¹⁰ Ohm-cm, about 10¹⁰ to about 10¹³ Ohm-cm, about 10⁹ Ohm-cm to about 10¹¹ Ohm-cm, about 10⁹ Ohm-cm to about 10¹⁰, or about 10¹⁰ Ohm-cm to about 10¹¹ Ohm-cm.

However, in some examples in which the respective thickness (T2) may be on the order of at least hundreds of microns, then the first adhesion-promoting layer 32 may be implemented with an anisotropic structure as described above such that migrating charges may readily flow out of plane (instead of in the plane of an airborne-charge receiving surface 256 (FIG. 5).

Via such resistivities and associated thicknesses of the first adhesion-promoting layer 32, such arrangements may help to prevent an undesired amount of charge accumulation on a surface of an airborne-charge receiving layer (e.g. 256 in FIG. 5-6 overlying the moisture vapor barrier 30 and first adhesion-promoting layer 32) and/or help to prevent an undesirable amount of lateral spreading of charges on such an airborne-charge receiving surface and/or as the charges migrate from such an airborne-charge receiving layer (e.g. 256 in FIGS. 5-6) to the counter electrode layer (e.g. 252 in FIGS. 5-6).

In some examples, the electrical resistivity parameter of the first adhesion-promoting layer 32 may be met without the use of additive particles and/or fillers (aimed at affecting resistivity), such as but not limited to carbon black, copper, indium tin oxide. silver, antimony tin oxide, aluminum-doped zinc oxide, carbon nanotubes, magnetite, and the like. Accordingly, in some examples, the first adhesion-promoting layer 32 omits such resistivity parameter additive material(s).

In some examples, when in a liquid state, the first adhesion-promoting layer comprises a wettability contact angle relative to the first side of the media layer of less than about 50 degrees. Among other aspects, the wettability contact angle may minimize “beading” of the first adhesion-promoting layer on the outer surface of the first side of the media layer. In some examples, the wettability contact angle is less than about 40 degrees, is less than about 45 degrees, is less than about 55 degrees, or is less than about 60 degrees.

In some examples, the example first adhesion-promoting layer 32 may comprise parameters in addition to the above-described electrical resistivity and wetting contact angle.

FIG. 3 is a diagram 150 schematically representing at least some example parameters 155 of an example first adhesion-promoting layer 32. As shown in FIG. 3, the parameters 155 may comprise the above-described electrical resistivity parameter 160 and wettability (e.g. contact angle) parameter 162. In some examples, both the electrical resistivity parameter 160 and the wettability contact angle parameter 162 may be implemented via a single ingredient.

For instance, in some examples, a first ingredient may comprise a low polarity monomer and in some examples, the first ingredient may comprise a glass transition temperature less than about 20 degrees C.

In some examples the first ingredient comprises a silicone acrylate, silicone epoxy, alkyl acrylate, alkyl epoxy, and combinations thereof. In some such examples, the first ingredient may comprise an acryloxy terminated ethyleneoxide, dimethysiloxane-ethyleneoxide aba block copolymer material.

In some examples, the first ingredient may comprise a percentage weight 40 percent of the material of the entire first adhesion-promoting layer 32.

In some examples, the electrical resistivity and wettability may be implemented via separate ingredients rather than a single ingredient.

In addition, as further shown in FIG. 3, an example first adhesion-promoting layer 32 may further comprise a flexibility parameter 164, an elastic modulus parameter 166, adhesion parameter 167, a compatibility parameter 168, a residual stress parameter 170, a surface smoothness parameter 172, and/or a print quality parameter 174.

In some examples, the first adhesion-promoting layer 32 may comprise a flexibility parameter 164 by which the first adhesion-promoting layer is to withstand bending, without cracking, to a radius of curvature less than about 50 mm. In some examples, the first adhesion-promoting layer 32 is able to withstand bending, without cracking, to a radius of curvature less than about 50 to about 300 mm. Among other aspects, the flexibility parameter 164 contributes toward maintaining structural integrity and compatibility of flexibility with other layers of an e-paper assembly, such as at least media layer 34, moisture vapor barrier 30, etc.

In some examples, via the elastic modulus parameter 166, the first adhesion-promoting layer 32 may comprise an elastic modulus greater than 100 MPa and in some such examples, the elastic modulus also may comprise less than about 10 GPa. Among other aspects, having a relatively high elastic modulus (e.g. above 100 MPa) may prevent or reduce cracking and/or wrinkling in the moisture vapor barrier 30, which in turn may otherwise compromise the effectiveness of the barrier 30 against moisture vapor. In some examples, the elastic modulus parameter 166 may sometimes be referred to as mechanical stiffness parameter. In some examples, the elastic modulus parameter 314 may be implemented via a second ingredient of material forming the first adhesion-promoting layer 32 and may comprise a monomer-oligomer unit having a number of polymerizable subunits greater than 2 so as to increase the elastic modulus/stiffness. In some such examples, the second ingredient may comprise a dipentaraerythritol penta-hexacrylate material.

In some examples, the second ingredient comprises about percentage weight 30 percent of the material of the entire first adhesion-promoting layer 32.

In some examples, the first adhesion-promoting layer 32 may comprise an adhesion parameter 167. As shown in FIG. 1, the first adhesion-promoting layer 32 comprises a first side 31A facing the first side 35A of the media layer 34, and a second 31B side facing a second side 33B of the moisture vapor barrier 30 (a side facing media layer 34). Via the adhesion parameter 167, both the respective first and second sides (31A, 31B) of the first adhesion-promoting layer 32 does not exhibit any or significant delamination or buckling upon the bending to a radius of curvature of less than 250 mm after a completed e-paper assembly (including the first adhesion-promoting layer 32) has been subject to 12 hours or less at temperatures from about 15 to about 40 degrees C. and relative humidities from about 15 percent to about 90 percent.

In some examples, the first adhesion-promoting layer 32 may comprise a compatibility parameter 168. In some examples, the first adhesion-promoting layer 32 may comprise a third ingredient to act as a compatibility agent to promote compatibility of the respective first and second ingredients. It will be understood that in some examples, the first ingredient (to provide electrical resistivity) and the second ingredient (to provide mechanical stiffness) are sufficiently compatible that the third ingredient may be omitted.

In some examples, the third ingredient includes a number of polymerizable subunits greater than two and includes a low polarity monomer. In some examples, the low polarity monomer may comprise a silicone acrylate, silicone epoxy, alkyl acrylate, alkyl epoxy. In some such examples, the low polarity monomer may comprise acryloxypropyl methysiloxane homopolymer and in some examples may comprise about 20 percent weight percentage of the entire material comprising the first adhesion-promoting layer 32.

In some examples, the first adhesion-promoting layer 32 may comprise a fourth ingredient comprising a viscosity reduction parameter, which in some examples may comprise a viscosity less than 1000 cPs and in some examples a glass transition temperature greater than about 40 degrees C. In some such examples, the fourth ingredient may comprise a tricyclodecane dimethanol diacrylate material. In some such examples, the fourth ingredient may comprise about 10 percent weight percentage of the entire material from which the first adhesion-promoting layer 32 is formed.

In some examples, the first adhesion-promoting layer 32 may comprise a fifth ingredient comprising a photoinitiator, such as when ultraviolet (UV) curing is employed. In some such examples, the photoinitiator may exhibit solubility in the larger formulation, absorption in wavelengths of interest, and will induce/cause polymerization of the entire formulation. In some such examples, the photoinitiator may comprise 2-benzyl-2-diemethylamino-1-(4-morpholinophenyl)-butanone-1. In some such examples, the photoinitiator may comprise about 1 percent weight percentage of the entire formulation from which the first adhesion-promoting layer 32 is formed.

As previously noted, the first adhesion-promoting layer 32 may comprise a residual stress parameter 170, a surface smoothness parameter 172, and/or a print quality parameter 174. In some examples, such parameters may be implemented via at least one of the previously identified ingredients, while in some examples, such parameters may be implemented by additional ingredients.

In some examples, the residual stress parameter 170 corresponds to a residual stress in at least the media layer 34 of the e-paper assembly 20 after application of the first adhesion-promoting layer 32 to the media layer 34. In some such examples, via the residual stress parameter 170, an additional curvature of the entire e-paper assembly 20 after coating with the first adhesion-promoting layer 32 does not exceed 1/50 mm⁻¹. Via satisfying the residual stress parameter 170, the first adhesion-promoting layer 32 may contribute to the robust, effective operation of the moisture vapor barrier 30 despite the dissimilarity of some aspects of the inorganic material of the moisture vapor barrier 30 relative to the aspects of the organic material of the media layer 34.

In some examples, a surface smoothness parameter 172 of the first adhesion-promoting layer 32 comprises a total height of roughness (Rt) profile less than 250 nanometers along an evaluation length of 200 microns.

In some examples, the first adhesion-promoting layer 32 may comprise a print quality parameter 174 by which an effect on the observable image quality in the media layer 34 is measured as a comparison between the observable image before and after application of the first-adhesion promoting layer 32. In some such examples, the image quality may be measured according a lightness variation parameter regarding lightness observed in a direction generally perpendicular to a longitudinal axis of lines in a sample, imaged striped pattern on charge-responsive media layer 34. In some examples, desirable image quality may be achieved (for the first adhesion-promoting layer 32) when a variation in lightness after coating (with first adhesion-promoting layer 32) should be greater than 50 percent of the variation in lightness before the coating (of first adhesion-promoting layer 32).

As previously noted the moisture vapor barrier 30 of e-paper assembly 20 may comprise an inorganic material. Accordingly, in some instances, the moisture vapor barrier 30 may sometimes be referred to as being a non-plastic material and/or a non-glass material. In some instances, the moisture vapor barrier 30 may sometimes be referred to as being a non-metal material.

In some examples, the inorganic material of the moisture vapor barrier 30 comprises an inorganic oxide material. In some examples, the inorganic oxide material may comprise aluminum oxide, titanium oxide, aluminum, zirconium oxide, silicon oxynitride, and/or silicon oxide, and may comprise similar metal oxide materials in some examples. In some instances, such inorganic oxide materials may sometimes be referred to as a ceramic material. As just one example, in some instances the moisture vapor barrier 30 may be formed via applying a perhydropolysilizane material, such as via liquid coating, and then transformed via heating and UV radiation to a solidified thin film of silica.

In some examples, the inorganic material of the moisture vapor barrier 30 comprises a ceramic material, such as but not limited to, silicon nitride and/or similar materials.

In some examples, the inorganic layer forming the moisture vapor barrier (e.g. 30 in FIGS. 1-3) may be formed via one of the methods previously described above in association with FIG. 2. For instance, in some such examples, chemical vapor deposition may be used to form a moisture vapor barrier 30 comprising a ceramic material, such as silicon nitride (SiN). In some examples, atomic layer deposition was used to aluminum oxide (AlOx) as a moisture barrier layer.

In addition, in some examples the inorganic layer of moisture vapor barrier 30 may be formed and/or deposited via sputtering 194, evaporation 196, and ion beam deposition 198, as shown in FIG. 4. The evaporation 196 may be implemented as e-beam evaporation or thermal evaporation. In some examples, such thin film deposition methods also may be employed to form a first adhesion-promoting layer 32 and/or second adhesion-promoting layer 64.

In some examples, the moisture vapor barrier 30 may exhibit a moisture vapor transmission rate (MVTR) of less than about 0.1 g/m²/day at 38 degrees Celsius and 90% relative humidity. In some examples, the moisture vapor barrier 30 may exhibit a moisture vapor transmission rate (MVTR) of less than about 1 g/m²/week at 38 degrees Celsius and 90% relative humidity.

In some examples, such moisture vapor transmission rate (MVTR) may be achieved via moisture vapor barrier 30 having a thickness (T1 in at least FIGS. 1, 5-6, 10) of between about 1 and about 1000 nanometers, and in some examples, a volume electrical resistivity between a lower limit of about 10⁹ Ohm-cm and an upper limit of about 10¹³ Ohm-cm. In some examples, the lower limit of resistivity exhibited by the inorganic moisture vapor barrier 30 is high enough to enable sufficient migration of charges through the moisture vapor barrier 30 (from charge receiving layer 256 to charge-responsive media layer 34) to enable writing high quality images on the charge-responsive media layer 34 and to avoid image blurring. In some examples, the higher limit of resistivity exhibited by the inorganic moisture vapor barrier 30 is sufficient to avoid too excessive charge accumulation on an external surface (e.g. imaging surface) of the airborne-charge receiving layer 256. In some such examples, this higher limit curtails excess charge accumulation, which in turn may minimize or avoid inadvertent modifications of an image (displayed on charge-responsive media layer 34) which may occur during user handling of the e-paper assembly 20 if such excess charge accumulations were present.

In some examples, the moisture vapor barrier 30 may comprise an electrical resistivity of about 10¹⁴ Ohm-cm or at least about 10¹⁴ Ohm-cm, such as when the moisture vapor barrier 30 has a sufficiently small thickness such as on the order of a submicron thickness while exhibiting a breakdown voltage of less than about 20 Volts, in some examples. In some examples, the breakdown voltage may be slightly higher such as 30 or 40 Volts.

In some instances, this electrical resistivity of about 10¹⁴ Ohm-cm (or even at least about 10¹⁴ Ohm-cm) may be at least one (or even two or three) orders of magnitude less than an electrical resistivity of some available organic materials (e.g. polychlorotrifluroethylene or available barrier films made of multiple layers of inorganic-organic assemblies) which have been sometimes used to attempt prevention of moisture vapor intrusion. Such relatively larger resistivities in such available organic polymers or multiple layer barrier films may significantly prohibit desired migration of charges if one attempted to deploy them in a passive e-paper assembly according to at least some examples of the present disclosure.

In some examples, such as when the inorganic moisture vapor barrier 30 may have a thickness of about 1 micron (e.g. a maximum in some examples), the inorganic moisture vapor barrier 30 may comprise dielectric strength of about 20 Volts/micron (or less than about 20 Volts/micron) such that the maximum surface charge (e.g. breakdown voltage) would be less than 20 Volts. In one aspect, the breakdown voltage equals a thickness multiplied by the dielectric strength, wherein the dielectric strength may represent the maximum electrical field that a material can experience before charge conduction starts to occur. With this in mind, the breakdown voltage may represent the maximum voltage difference that a material can experience before charge conduction starts to occur. Via such arrangements, the relatively thin structure and intrinsic nature of the inorganic material would be expected to result in insignificant charge accumulations at a surface of the moisture vapor barrier 30 and/or an airborne-charge receiving layer (e.g. FIGS. 5-6). In at least this way, excess charge accumulation and/or blurring (in some cases) may be avoided such that high quality image formation and/or retention may occur for the example passive e-paper assembly.

At least some such example arrangements of a moisture vapor barrier 30 of the present disclosure stand in sharp contrast to the at least some organic materials (attempted to be used for moisture vapor barriers) having a very high resistivity (e.g. 10¹⁸ Ohm-cm) and typically implemented in thicknesses of at least about 10 microns, while exhibiting a breakdown voltage of about 200 Volts or more than 200 Volts. If one attempted to use such arrangements for moisture vapor barrier (such as 30 in FIG. 1), a surface charge build-up of about 200 Volts (or more) likely would occur, which would interfere with quality image retention related to unintentional impact of such charges on the image at charge-responsive media layer 34 during handling of the e-paper assembly 20. In some cases, such an arrangement may result in blurring of an image at charge-responsive media layer 34.

In some examples, the thickness (T1) of the moisture vapor barrier 30 is about 10 to about 2500 nanometers. In some examples, the thickness (T1) is about 15 to about 300 nanometers. In some examples, the thickness (T1) is about 20 to 200 nanometers.

While not shown for illustrative simplicity in at least FIGS. 1, 5-6, and 10, it will be understood that in at least some examples, the edges of the e-paper assembly 20 (e.g. edges of the respective media layer, charge-receiving layer, counter electrode layer, etc.) are sealed to prevent intrusion of moisture, whether in the form of liquid and/or vapor.

The above-noted low permeability of the example inorganic moisture vapor barrier (layer) stands in sharp contrast to at least some organic polymer materials, which exhibit a relatively high level of permeability to water vapor such that the pertinent thickness of such organic polymers may be prohibitively thick for use in a flexible, passive e-paper display media (e.g. assembly). For instance, a pertinent thickness of at least some of those organic polymer materials to function well as a moisture vapor barrier may be on the order of tens of microns, which is substantially greater than a thickness of at least some of the example inorganic moisture vapor barrier of the present disclosure. In some examples, in at least this context the term “substantially greater” refers to a difference in thicknesses of at least 25%, 250%, 75%, 100% or even 2×, 3×, etc. difference. In some examples, in at least this context the term “substantially greater” refers to a difference in thicknesses of at least one (or at least two or three) orders of magnitude difference.

With this in mind, it will be understood that, some example inorganic moisture vapor barriers of the present disclosure may have an intrinsic moisture vapor permeability substantially less than the moisture vapor permeability of some of the above-identified high thickness organic polymers. In some examples, in at least this context the term “substantially less” refers to a difference in permeability of at least 25%, 250%, 75%, 100% or even 2×, 3×, etc. difference. In some examples, in at least this context the term “substantially less” refers to a difference in permeability of at least one (or at least two or three) orders of magnitude difference.

In some examples, the intrinsic relatively low permeability of the example inorganic moisture vapor barrier permits the barrier to be relatively thin, which contributes to the flexibility of the e-paper assembly. Moreover, this thinness in turn permits use inorganic materials having relatively large resistivities with little or no diminishment of image quality on the e-paper assembly.

Via such arrangements, the charge-responsive re-writable media layer 34 is protected from moisture vapor (e.g. humidity) such that information displayed on the e-paper assembly (e.g. 20) retains its image quality for extended periods of time despite the presence of moisture vapor. It will be understood that such protection from moisture vapor is distinct from a general water resistance of an airborne-charge receiving layer (e.g. 256), counter electrode layer (e.g. 252), edges of the passive e-paper assembly, etc. such as when the e-paper assembly is temporarily exposed to spilled liquid, rain drops, etc. Moreover, in least some examples, other portions of an e-paper assembly or display device (e.g. a counter electrode layer, etc.) may provide a sufficient moisture vapor barrier 30 on a non-imaging side of the e-paper assembly even if such layers are organic because a greater thickness is permissible in that particular location and/or charges need not migrate through such layers. Accordingly, in some examples the inorganic moisture vapor barrier layer 30 interposed between the airborne-charge receiving layer (e.g. 256) and the charge-responsive media layer 34 may comprise the sole inorganic moisture vapor barrier 30 of an e-paper assembly. In such an arrangement, the inorganic moisture vapor barrier 30 is located on the imaging side or surface of the e-paper assembly.

Robust retention of image quality in a passive e-paper display media (e.g. assembly) under a wide variety of environmental conditions may enhance the ability of such passive e-paper display media to function as a gift card, display card, employee badge, guest badges, access badge, transaction medium, etc.

FIG. 5 is a side view schematically representing an example passive e-paper assembly 250 comprising at least some of substantially the same features and attributes as the passive e-paper assembly 20 (FIGS. 1-4), except further comprising an airborne-charge receiving layer 256 and/or a counter electrode layer 252.

As shown in FIG. 5, the airborne-charge receiving layer 256 is disposed on the first side 35A of the charge-responsive media layer 34 with airborne-charge receiving layer 256 formed or otherwise applied onto moisture vapor barrier 30.

In some examples, it will be understood that, even in the absence of airborne-charge receiving layer 256 (in some examples), charge-responsive media layer 34 is imageable by charges (e.g. FIG. 10) and that layer 256 may be provided for protection against unintentional and/or malicious mechanical and electrical insults to charge-responsive layer 34. Nevertheless, in at least some examples of the present disclosure, the presence of the airborne-charge receiving layer 256 facilitates producing and retaining quality images at charge-responsive media layer 34 in the manner described herein. In some examples, and as further described below, at least airborne-charge receiving layer 256 may comprise an anisotropic structure to facilitate the migration of charges (e.g. written by an imager unit 609 in FIG. 10) on charge-responsive media layer 34.

In some examples, the thickness and type of materials forming airborne-charge receiving layer 256 are selected to mechanically protect at least the charge-responsive media layer 34 (including microcapsules 608 shown in FIG. 10) from punctures, abrasion, bending, scratching, liquid hazards, crushing, and other impacts. Moreover, in some examples the airborne-charge receiving layer 256 also may protect the charge-responsive media layer 34 from tribo charges.

With further reference to FIG. 5, in some examples, the airborne-charge receiving layer 256 comprises a thickness (T5) of between about 20 to about 200 microns, and may comprise organic material(s). In some examples, the airborne-charge receiving layer 256 may comprise an UV curable acrylate, among other materials. In some examples, the airborne-charge receiving layer 256 may comprise an additive, such as magnetite particles, in order to exhibit anisotropic properties to facilitate migration of charges toward the charge-responsive media layer 34. Accordingly, in some such examples, the airborne-charge receiving layer 256 may sometimes also be referred to as an anisotropic layer.

In at least the example later shown in FIGS. 5-6, the moisture vapor barrier 30 is located interior to an airborne-charge receiving layer (e.g. 256 in FIGS. 5-6) such that the relatively thin moisture vapor barrier is protected structurally. In some such examples, this interior location may be relatively more effective for humidity protection than if the moisture vapor barrier 30 were attempted to be placed outside the airborne-charge receiving layer (e.g. 256).

However, in some examples, the moisture vapor barrier 30 may be located external to the airborne-charge receiving layer 256. In some such examples, touching or handling of the e-paper assembly 20 (and in particular the moisture vapor barrier 30) would be significantly minimized or excluded completely in order to preserve the integrity of the moisture vapor barrier 30. In some such examples, among the variety of inorganic materials disclosed herein from which the moisture vapor barrier 30 may be formed, more durable materials may be selected when the moisture vapor barrier 30 is located external to the airborne-charge receiving layer 256. It will be further noted that such an external location of the moisture vapor barrier 30 in some examples is not believed to significantly affect the performance of the airborne-charge receiving layer 256 in view of the relatively thin structure of the moisture vapor barrier 30 and/or the sufficiently similar resistivity attributes of the moisture vapor barrier (as compared to the charge receiving layer 256).

As noted above, in some examples as shown in FIGS. 5-6, an e-paper assembly 250 may comprise a counter electrode layer 252, which provides a counter electrode for the imaging of e-paper display assembly by an imager unit (e.g. 609 in FIG. 10). In some instances, the counter electrode layer 252 may sometimes be referred to as a ground electrode or ground electrode layer. In some examples, the counter electrode layer 252 comprises a distinct conductive element 254 acting as a ground electrode.

With this in mind, the counter electrode layer 252 allows counter charges to flow to ground electrode from a writing module (e.g. imager unit 609 in FIG. 10). Thus, e-paper assembly 250 (FIG. 5) remains basically charge neutral despite charges being emitted onto airborne-charge receiving layer 256. Without a connection between counter electrode layer 252 and an imager unit (e.g. 609 in FIG. 10), no appreciable amount of charges can be emitted onto charge receiving layer 256 and thus no information can be written to charge-responsive media layer 34.

In some examples, instead of having a distinct conductive element 254 apart from a protective barrier 253, the counter electrode layer 252 may comprise a single element made of transparent conductive material, such as indium tin oxide. In some examples, counter electrode layer 252 may comprise an opaque conductive material, such as when the first side 25A may act as the viewing side of the e-paper display media 2250. In one example, counter electrode layer 252 has a thickness (T4) between 5 nm and 1 mm.

FIG. 6 is a side view schematically representing an example passive e-paper assembly 260 comprising at least some of substantially the same features and attributes as the passive e-paper assembly 20 (FIG. 1) and/or passive e-paper assembly 250 (FIG. 5), except further comprising a second adhesion-promoting layer 264. In at least some examples, the second adhesion-promoting layer 32 may enhance adhesion between the airborne-charge receiving layer 256 and the moisture vapor barrier 30. In some examples, the second adhesion-promoting layer 264 may comprise at least some of substantially the same features and attributes as the first adhesion-promoting layer 32, except being positioned between airborne-charge receiving layer 256 and moisture vapor barrier 30.

However, in some examples, the second adhesion-promoting layer 264 may comprise some attributes and features which differ from those employed for the first adhesion-promoting layer 32.

For instance, in some examples, a second adhesion-promoting layer 305 (e.g. 264 in FIG. 6) may comprise a hybrid material 212, as shown in the diagram 300 of FIG. 7. In some examples, the hybrid material comprises at least one inorganic functional group and at least one organic functional group. In some such examples, the hybrid material may comprise an organosilane material, such as tetraethoxysilane (TEOS), silsesquioxane, etc.

In some examples, the second adhesion-promoting layer 305 (e.g. 264) may be formed via tetraethoxysilane (and similar materials) using via surface silanazation 306 (or other techniques), as represented in FIG. 7.

In some examples, the second adhesion-promoting layer 264 may be implemented via plasma modification 304 as shown in FIG. 7. In particular, the second adhesion-promoting layer 264 may be implemented as a surface defined on a first side 257A of the airborne-charge receiving layer 256, which generally faces the charge-responsive media layer 34. In some examples, the second adhesion-promoting surface 257A (acting as layer 264) may be implemented via plasma modification 304 as shown in the diagram 300 of FIG. 7. For instance, via exposure to a gaseous plasma, the surface defining the first side 257A of the airborne-charge receiving layer 256 may be transformed chemically into an adhesion-promoting surface to facilitate bonding relative to the first side 33A of inorganic moisture vapor barrier 30.

In some examples, the inorganic moisture vapor barrier 30 and/or the first, second adhesion-promoting layers 32, 264 may be transparent or translucent. In some such examples, airborne-charge receiving layer 256 may be omitted or also be made transparent/translucent.

In some examples, the first adhesion-promoting layer 32 (FIGS. 1-3), second adhesion-promoting layer 264 (FIG. 2), the inorganic material vapor barrier 30 (FIG. 1), and/or an airborne-charge receiving layer 256 (FIG. 2) may comprise additives which confer the ability to dissipate static charge. In some examples, such additives can be either conductive particles or molecular additives. In some examples, such conductive particles have diameters in the range of tens of nanometers to tens of micrometers and can be from several classes of materials. These materials may comprise metallic materials such as silver, conductive oxide materials such as indium tin oxide, intrinsically conducting polymer materials such as polyaniline, or magnetic materials such as magnetite.

In addition, in some examples, the additive particles can be aligned in a magnetic or electric field to enhance conductivity in one direction such as the out-of-plane direction. In some instances, a material or layer having such alignment may sometimes be referred to being anisotropic. In some instances, by embodying an anisotropic structure, a layer (e.g. airborne-charge receiving layer 256) may enhance migration of charges to the charge-responsive media layer 34.

In some examples, molecular additives may comprise quaternary ammonium salts. One quaternary ammonium salt may comprise tetrabutylammonium hexafluorophosphate.

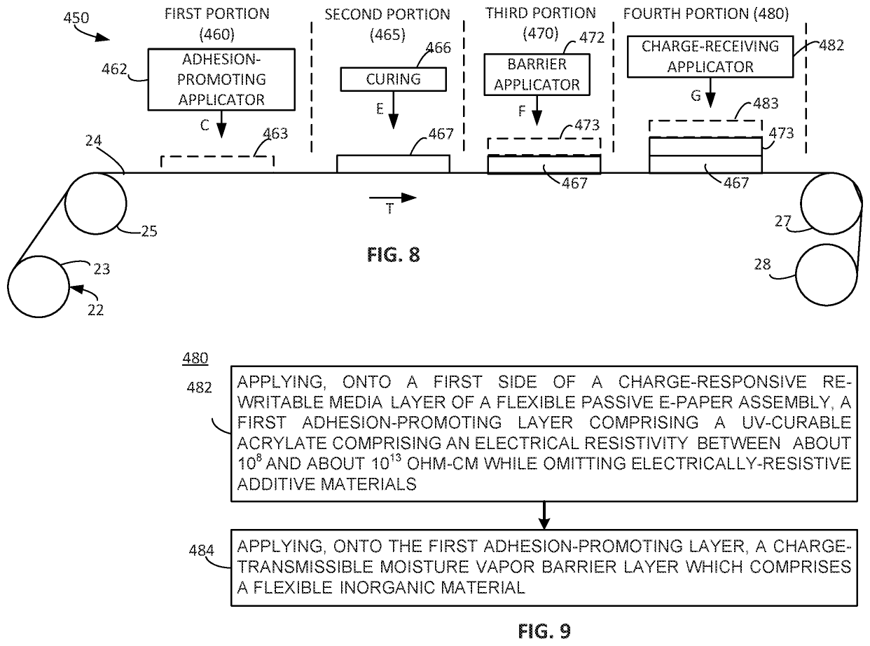

FIG. 8 is a diagram including a side view schematically representing an example device to implement an example e-paper assembly comprising at least some of substantially the same features as described in association with FIGS. 1-7 and 9-11B. It also will be understood that FIG. 8 also may be viewed as schematically representing an example method of manufacturing of at least a portion of an e-paper assembly comprising at least some of substantially the same features as described in association with FIGS. 1-7 and 9-11B.

As shown in FIG. 8, a device 450 comprises a web supply 22 and various portions involved in applying and forming layers of an example e-paper assembly (e.g. 20, 250, 260, 600) as described in association with at least FIGS. 1-7 and 9-11B. In some examples, the web supply 22 may comprise a series of rollers 23, 25, 27, 28, etc. by which an e-paper assembly media may be manufactured along a travel path T. In some examples, device 450 may correspond to a roll-to-roll manufacturing device by which a stock e-paper media 24 (including at least a media layer, such as 34, 634) is supplied via a roll (e.g. 23) and various additional layers are applied and formed on the stock e-paper before being collected into a roll, such as roller 28.

As shown in FIG. 8, in some examples device 450 comprises a first portion 460 in which an adhesion-promoting applicator 462 is to apply (arrow C) a liquid coating or perform vapor deposition of a first adhesion-promoting layer 463 (e.g. 32 in FIGS. 1, 5-6, 11) onto e-paper media 24, such as onto a charge-responsive media layer 34 of a stock e-paper media 24.

In some examples, such as when the first adhesion-promoting layer 463 is applied in a liquid phase, the device 450 comprises a second portion 465 in which a curing element 466 applies heat or other energy (e.g. UV, Infrared), as represented via arrow E, to cure the deposited first adhesion-promoting layer 463 into a solid layer 467. In the case of vapor deposition and related methods, the second portion 465 may be omitted.

In some examples, the device 450 comprises a third portion 470 comprising a barrier applicator 472 to apply (arrow F) and form a barrier, such as a moisture vapor barrier 473, onto the first adhesion-promoting layer 467. In some examples, the barrier applicator 472 may comprise the same or substantially the same features and attributes as applicator 462, and therefore employ liquid phase modalities or other deposition modalities (e.g. vapor deposition, atomic layer deposition, sputtering, etc.) as previously described for moisture vapor barrier 30.

In some examples, the device 450 comprises a fourth portion 480 comprising a charge-receiving applicator 482 to apply and form an airborne-charge receiving layer 483 (e.g. 256 in FIGS. 5-6, 11) onto the moisture vapor barrier 473 of the e-paper assembly 485 being formed (and including e-paper media 24). In some examples, the barrier applicator 482 may comprise the same or substantially the same features and attributes as applicators 462, 472.

In one aspect, the device 450 may be viewed as employing a roll-to-roll arrangement to facilitate an integrated deposition of the various barrier layers (e.g. 32, 30, 256) relative to an e-paper media 24. In addition, as previously mentioned, in some examples the application of the various barrier layers may be performed under atmospheric conditions (e.g. pressure) such as previously described in association with at least FIGS. 2-4, thereby avoiding exposing the e-paper media 24 (and added layers) to very low relative humidity for extended periods of time or even at all.

It will be understood that for illustrative purposes the various layers, elements are not necessarily shown to scale.

FIG. 9 is a flow diagram of an example method 480. In some examples, method 480 may be performed via at least some of the e-paper assemblies, layers, materials, methods, etc. as described in association with at least FIGS. 1-8 and 10-11B. In some examples, method 480 may be performed via at least some e-paper assemblies, layers, materials, methods, etc. other than those described in association with at least FIGS. 1-8 and 10-11B. As shown at 482 in FIG. 9, method 480 may comprise applying, onto a first side of a charge-responsive re-writable media layer of a flexible passive e-paper assembly, a first adhesion-promoting layer comprising a UV-curable acrylate comprising an electrical resistivity between 10⁸ and 10¹³ Ohm-cm while omitting electrically-resistive additive materials. In some examples, materials other than a UV-curable acrylate may be used to form the first adhesion-promoting layer and to implement the electrical resistivity. As shown at 484 in FIG. 9, method 480 comprises applying, onto the first adhesion-promoting layer, a charge-transmissible moisture vapor barrier layer which comprises a flexible inorganic material. In some examples, the flexible inorganic material comprises silicon nitride (SiN).

FIG. 10 is a diagram 2601 including a cross-sectional view schematically representing one example e-paper assembly 600 and a side plan view schematically representing an example imager unit 609. In some examples, e-paper assembly 600 comprises at least some of substantially the same features and attributes of the e-paper assemblies (e.g. 20, 250, 260), as previously described in association with at least FIGS. 1-9.

In some examples, charge-responsive media layer 634 of e-paper assembly 600 provides one example implementation for charge-responsive media layer 34 of an e-paper assembly (e.g. 20, 250, 260) as previously described and illustrated with reference to at least FIGS. 1-9. As shown in FIG. 10, e-paper assembly 600 comprises an airborne-charge receiving layer 256, moisture vapor barrier 30, first adhesion-promoting layer 32, and charge-responsive media layer 634, with similar reference numerals referring to like elements in at least FIGS. 1-9. It will be understood that in some examples e-paper assembly 600 may comprise a second adhesion-promoting layer 264 as in the examples of FIGS. 5-6.

In some examples, the external surface 55 of counter electrode layer 252 comprises a viewing side 25B of the e-paper assembly 600 as represented by the directional arrow V1. Meanwhile, external surface 257B of airborne-charge receiving layer 256 provides the surface at which charges are applied (e.g. an imaging surface) for e-paper assembly 600.

As shown in FIG. 10, in some examples the charge-responsive media layer 634 includes microcapsules 608 encapsulated by a resin or polymer 614. In one example, each microcapsule 608 includes black particles 610 and white particles 611 suspended in a fluid medium 616.

In some examples, when held in a viewing position, ambient light is transmitted through a transparent (or translucent) counter electrode layer 252, strikes microcapsules 608, and is reflected back to the viewer V1. In instances in which white particles 611 of a microcapsule 608 are located near counter electrode layer 252, the respective microcapsule 608 appears white to a viewer V1. However, when black particles 610 of a microcapsule 608 are located near counter electrode layer 252, the respective microcapsule 608 appears black to the viewer V1. The particles 610 and 611 have opposite charges. For example, black particles 610 can be positively charged particles, and white particles 611 can be negatively charged particles, such that when ions (e.g. positive or negative charges) are written to the charge-responsive media layer 634, the respective particles 610, 611 respond according to the respective attractive or repelling forces. Various shades of gray can be created by varying the arrangement of alternating microcapsules with white and black particles located near counter electrode layer 252 to produce halftoning.

With this in mind, as further shown in FIG. 10, an imager unit 609 comprises an erasing head 612 and a writing head 614. In some examples, the respective heads 612, 614 may comprise an ion-based technology, which generates charges from a corona and emits the charges, via an individually addressable electrode array, in a selectable pattern toward the charge receiving layer 256. In some examples, other energy sources may be used to generate the ions, e.g. positive and/or negative charges.

The imager unit 609 and e-paper assembly 600 are arranged for relative movement to each other. For instance, the e-paper assembly 600 may be movable relative to a fixed imager unit 609 or the imager unit 609 may be movable relative to an e-paper assembly 600 in a temporarily fixed position. The imager unit 609 is spaced apart from the external surface 257B of charge responsive layer 256, such that charges emitted from imager unit 609 travel airborne to first side 257B of charge responsive layer 256. In the particular example shown in FIG. 10, the imager unit 609 is shown moving in direction A (when e-paper assembly 600 is fixed) or the e-paper assembly 600 media is shown moving in direction B (when imager unit 609 is fixed). During such relative movement, in some examples the erasing head 612 emits a plurality 618 of negative charges 619 onto charge receiving layer 256 to erase any prior image held by the media layer 634. Then the writing head (W) 614 emits a plurality 616 of positive charges 617 in a selectable pattern (e.g. via an addressable electrode array) onto charge-receiving layer 256. In general, a sufficient number of the charges 617 migrate through the charge-receiving layer 256 and through the moisture vapor barrier 30 such that the charges affect the distribution of the black and white particles 610, 611 within microcapsules 608 at selected positions of an array of microcapsules. In the example shown, because the black particles 610 are positively charged, they are repelled away from the positive charges applied at charge receiving layer 256 while the white particles 611 (which are negatively charged) are attracted to the positive charges applied to the charge receiving layer 256. As a result, the black particles 610 in the selected microcapsules 608 form an image viewable from side 25B, as represented by the directional arrow V1.

In some examples, as represented by the directional arrow V2, the surface 257B at the charge receiving layer 256 may comprise the viewing surface/side of the e-paper assembly 600. Accordingly, in such examples, the charge receiving layer 256 comprises both the imaging side of the e-paper assembly 600 and the viewing side of the e-paper assembly 600.

In some examples, the black particles 610 can be negatively charged particles, and white particles 611 can be positively charged particles. In some such examples, the polarity of the respective erasing and writing heads 612, 614 of the imaging unit 609 may be reversed.

Microcapsules 608 exhibit image stability using chemical adhesion between particles and/or between the particles and the microcapsule surface. For example, microcapsules 608 can hold text and images indefinitely without using electricity, while allowing the text or images to be changed later.

In some examples, the diameter of each microcapsule 608 is substantially constant within layer 634 and can be in one example between 20 μm and 100 μm, such as 250 μm. In some examples, at least a portion of counter electrode layer 252 can be composed of a transparent conductive material, such as indium tin oxide, or an opaque material.

E-paper assembly 600 may have a variety of other configurations. In some examples, each microcapsule 608 may include black particles suspended in a white colored fluid. The black particles can be positively charged particles or negatively charged particles. One or more microcapsules form a pixel of black and white images displayed on e-paper assembly 600. The black and white images are created by placing black particles near or away from counter electrode layer 252 (when surface 55 is the viewing side—V1) or from charge receiving layer 256 (when surface 257B is the viewing side—V2). For example, microcapsules 608 having black particles 610 located away from counter electrode layer 252 reflect white light, corresponding to a white portion of an image displayed on e-paper assembly 600 as viewable on a first viewing side V1. In contrast, the microcapsules with black particles located near counter electrode layer 252 appear black to a viewer V1 corresponding to a black portion of the image displayed on e-paper display 600. Various shades of gray can be created by using halftoning with black particles located near or away from counter electrode layer 252.

With these example implementations in mind regarding at least FIG. 10, in some instances, some organic polymer arrangements may not be suitable for use as a moisture vapor barrier (e.g. layer 32) because they exhibit a very large volume resistivity, such as 10¹⁸ Ohm-cm. If such materials were attempted to be used as layer 32 in some of the example e-paper assemblies, a large accumulation of charges (emitted from imager unit 609 in FIG. 10) may build up on surface 257B on charge receiving layer 256 instead of such charges being allowed to migrate to charge-responsive media layer 634. In some instances of using such very large resistivity volume, organic polymer arrangements (instead of the example inorganic moisture vapor barrier), a combination of the high resistivity and the build-up of charges on the surface may cause incoming emitted charges (from an imager unit) to be deflected laterally, which may result in a blurring of the image to be displayed via a charge-responsive media layer. In addition, in such very large resistivity volume, organic polymer arrangements, the surface of such layers may exhibit a relative low surface resistivity, which might in turn cause charges (emitted from an imager unit) to flow along the surface of the layer, thereby resulting a blurring of the image displayed via a charge-responsive media layer.

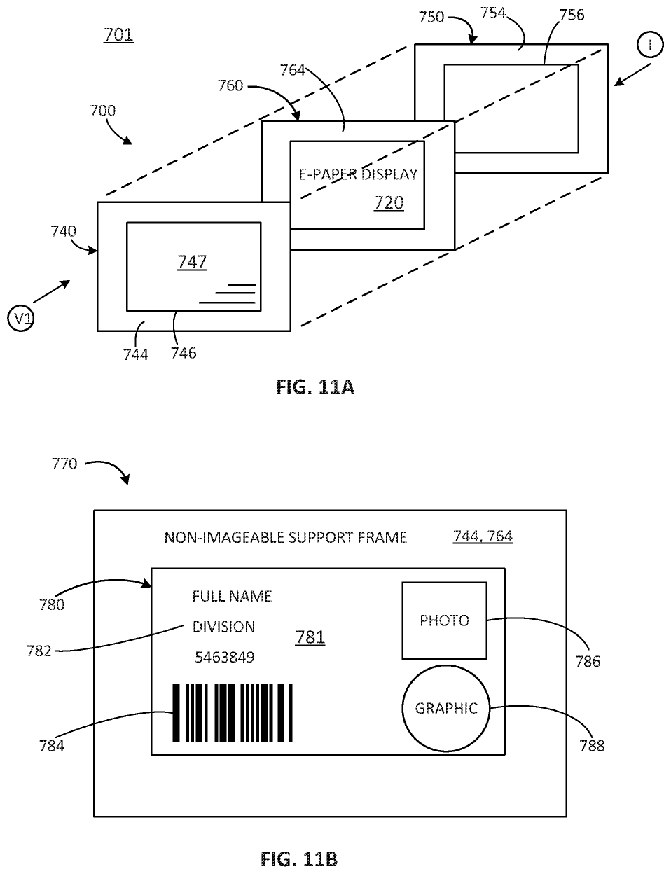

FIG. 11A is a diagram 701 including an exploded view schematically representing an example a passive e-paper display device 740. As shown in FIG. 11A, in some examples display device 700 may comprise support members 740, 750, 760 which are formed about and/or secured relative to an e-paper display 720 (e.g. e-paper assembly 20, 250, 260, 600 in FIGS. 1, 5-6, 10). In one aspect, such arrangements may facilitate the passive e-paper display 720 to function as a gift card, employee badge, display card, transaction medium, etc. In some examples, one support member 760 comprises a frame 764 formed about and/or on the edges of the passive e-paper display 720. In some examples, support member 760 may be further sandwiched between a first outer support member 740 and a second outer support member 750, as shown in FIG. 11A. The first outer support member 740 comprises a frame 744 defining a window 746 holding a transparent member 747 through which the passive e-paper display 720 is visible and viewable as represented via indicator V1. The second outer support member 750 comprises a frame 754 defining a window 756 through which a charge receiving layer (e.g. 256 in FIGS. 5-6, 10) of the passive e-paper display 720 will be accessible for imaging via an imager unit (e.g. 609 in FIG. 10), as represented via indicator 1.

Upon securing the respective support members 740, 760, 750 relative to each other, a single e-paper display device 700 provides a relatively thin, flexible e-paper display media which may enable robust use and handling in a wide variety of conditions while retaining high quality images on e-paper display 720. The e-paper display device 700 is configured to cooperate with an imager unit (e.g. 609 in FIG. 10) while still being usable and handled like any common gift card, identification card, access badge, etc. As such, the e-paper display device 700 is highly flexible, thin, light and resistant to wear, impact, etc. Moreover, with the inclusion of moisture vapor barrier 30 (e.g. FIGS. 1, 5-6, 11) within the e-paper display 720, the display device 700 can withstand high humidity conditions for an extended period of time without significantly affecting the image quality on e-paper display 720.

FIG. 11B is top plan view schematically representing an example e-paper display device 770. In some examples, the e-paper display device 770 comprises an e-paper assembly 780 supported via support frame (e.g. 744 and/or 764 in FIG. 11A). In some examples, e-paper assembly 780 comprises at least some of substantially the same features and attributes as the example e-paper assemblies (e.g. 20, 250, 260, 700), as previously described in association with at least FIGS. 1-11A. As represented in FIG. 11B, the support frame is a non-imageable support frame in that it does not embody re-writing images in the manner previously described for the example e-paper assemblies (20, 250, 260, 600). However, this does not preclude support frame (e.g. 744) from bearing images (e.g. text, graphics, photos) printed via non-e-paper technologies.

FIG. 11B also schematically represents at least some of the types of information which can form part of an image 781 on an e-paper assembly 780. For instance, image 781 may comprise text 782, such as alphanumeric expressions like names, numbers, etc. In some instances, image 781 may comprise machine readable markings 784, such as a bar code or QR code. In some instances, image 781 may comprise a photo 786 and/or a graphic 788.

It will be understood that in some instances, it may be desirable to retain such information in image 781 in a clear, accurate manner for an extended period of time. Hence, it will be apparent that the introduction of the moisture vapor barrier 30 (between the charge-receiving layer 256 and the charge-responsive media layer 34, 634 to prevent intrusion of moisture vapor) may play a significant role in quality image retention, which in turn may enhance accuracy and readability of the information displayed. This performance, in turn, may contribute to the widespread, robust use of such passive e-paper media.

Successful implementation of such moisture vapor barrier 30 may depend, at least in part, upon a robust, effective first adhesion promoting layer 32 which contributes the smoothness and structural integrity of the moisture vapor barrier 30, as previously described.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A passive e-paper assembly comprising:
a charge-transmissible moisture vapor barrier comprising a flexible inorganic material;
a charge-responsive, re-writable media layer; and
a first adhesion-promoting layer interposed between the moisture vapor barrier and a first side of the charge-responsive media layer, the first adhesion-promoting layer comprising a UV-curable acrylate comprising an electrical resistivity between about 10⁸ and about 10¹³ Ohm-cm, wherein the UV-curable acrylate, when in a liquid state, comprises a wettability contact angle relative to the first side of the media layer of less than about 50 degrees.

2. The passive e-paper assembly of claim 1, wherein the first-adhesion promoting layer is to withstand bending, without cracking, to a radius of curvature less than 50 mm.

3. The passive e-paper assembly of claim 1, wherein the first adhesion-promoting layer is to include a first ingredient to implement the electrical resistivity parameter and the wettability contact angle, wherein the first ingredient comprises a low polarity monomer having a glass transition temperature less than about 20 degrees C.

4. The passive e-paper assembly of claim 3, wherein the first ingredient comprises a silicone acrylate, silicone epoxy, alkyl acrylate, alkyl epoxy, and combinations thereof, with the first ingredient having a glass transition temperature less than about 20 degrees C.

5. The passive e-paper assembly of claim 4, wherein the first adhesion-promoting layer is to include a second ingredient to cause the first adhesion-promoting layer to exhibit an elastic modulus greater than about 100 MPa.

6. The passive e-paper assembly of claim 5, wherein the first adhesion-promoting layer comprises a third ingredient to act as a compatibility agent and including a number of polymerizable subunits greater than two and including a low polarity monomer.

7. The passive e-paper assembly of claim 1, comprising:
an airborne-charge receiving layer on a side of the moisture vapor barrier opposite the media layer.

8. The passive e-paper assembly of claim 8, comprising:
a second adhesion-promoting layer interposed between the airborne-charge receiving layer and the moisture vapor barrier, the second adhesion-promoting layer comprising at least one of:
a hybrid material including at least one inorganic functional group and at least one organic functional group; and
an organic polymer material.

9. An adhesion-promoting element comprising:
an organic polymer layer to be interposed between a charge-transmissible, moisture vapor barrier layer and a first side of a charge-responsive, re-writable media layer of a flexible, passive e-paper assembly,
wherein the moisture vapor barrier comprises a flexible inorganic material,
wherein the organic polymer layer comprises a first ingredient comprising a silicone acrylate, silicone epoxy, alkyl acrylate, alkyl epoxy, and combinations thereof, and the organic polymer layer comprises a second ingredient comprising a dipentaraerythritol penta-hexacrylate material,
wherein the adhesion-promoting element is to permit migration of charges from an airborne-charge receiving layer and the moisture vapor barrier layer through the inorganic polymer layer to the charge-responsive, re-writable media layer.

10. The adhesion-promoting element of claim 9, wherein via the second ingredient, the organic polymer layer comprises an elastic modulus between 100 MPa and 10 GPa, and wherein the organic polymer layer is able to withstand bending, without cracking, to a radius of curvature less than 50 mm.

11. A method of manufacturing comprising:
performing in a roll-to-roll arrangement:
applying, onto a first side of a charge-responsive re-writable media layer of a flexible passive e-paper assembly, a first adhesion-promoting layer comprising comprises an electrical resistivity between about 10⁸ and about 10¹³ Ohm-cm; and
applying, onto the first adhesion-promoting layer, a charge-transmissible moisture vapor barrier layer which comprises a flexible inorganic material.

12. The method of claim 11, wherein applying the charge-transmissible moisture vapor barrier layer comprises:
depositing, via plasma-assisted chemical vapor deposition, the flexible inorganic material and providing the flexible organic material as silicon nitride material.

13. The method of claim 11, wherein applying the charge-transmissible moisture vapor barrier comprises:
coating, via a liquid phase under atmospheric pressure, a perhydropolysilizane material onto the first adhesion-promoting layer; and
applying heat and UV radiation to cause the perhydropolysilizane material to form the moisture vapor barrier as a solidified thin film of silica.

14. The method of claim 11, wherein applying the first adhesion-promoting layer comprises applying the UV-curable acrylate, when in a liquid state, having a wettability contact angle relative to the first side of the charge-responsive, re-writable media layer of less than 50 degrees.

15. The method of claim 11, wherein applying the moisture vapor barrier layer comprises:
formulating the moisture vapor barrier layer to have a moisture vapor transmission rate (MVTR) of less than about 1 g/m²/week at 38 degrees Celsius and 90% relative humidity, at a thickness of between about 1 and about 1000 nanometers.
